(19) United States
(12) Patent Application Publication
(10) Pub. No.: US 2026/0226845 A1
(43) Pub. Date: Aug. 6, 2026

(54) Variable Vane and Lever Arm

(71) Applicant: RTX Corporation, Farmington, CT (US)

(72) Inventors: Samuel B. Hoyt, Farmington, CT (US); Fadi Samir Maalouf, East Hampton, CT (US)

(73) Assignee: RTX Corporation, Farmington, CT (US)

(21) Appl. No.: 19/045,720

(22) Filed: Feb. 5, 2025

(51) Int. Cl. F01D 17/16

(52) U.S. Cl. CPC F01D 17/16; F05D 2240/12; F05D 2260/31; F05D 2260/50

(57) ABSTRACT

A vane has: an airfoil having a first end and a second end; and a first shaft protruding from the first end of the airfoil. The first shaft has: a threaded distal portion; and proximally of the threaded distal portion, a first lateral facet and a second lateral facet opposite the first lateral facet. An upper end of the first facet is axially recessed relative to an upper end of the second facet.

### BACKGROUND

The disclosure relates to variable lever arms. More particularly, the disclosure relates to vane lever arms such as used for variable vanes of a gas turbine engine.

Gas turbine engines (used in propulsion and power applications and broadly inclusive of turbojets, turboprops, turbofans, turboshafts, industrial gas turbines, and the like) may include variable vane stages in one or more sections of the engine. In a variable vane stage, a circumferential array of vane airfoils are each rotatable about the respective associated axis of rotation. The vane airfoils may each be mounted for such a rotation to an inner diameter (ID) platform/shroud or inner casing and an outer diameter (OD) shroud or outer casing. Vane rotation may be driven by respective lever arms typically mounted to an outer diameter (OD) shaft of the vane.

Example vane lever arms extend between a driving end and a driven end. The driving end includes one or more features for mounting to a driver such as a synchronizing ring. The driven end includes one or more features for mounting to the associated vane OD shaft/stem to rotate said vane about its axis of rotation.

A number of constructions of vane arms exist. U.S. Pat. No. 10,161,260B2 (the ′260 patent) of Morganti et al., Dec. 25, 2018, entitled “Vane Lever Arm for a Variable Area Vane Arrangement”, discloses vane arms formed via bending sheet metal stock. The disclosure of the ′260 patent is incorporated by reference in its entirety herein as if set forth at length. The vane may be formed by bending a cut generally T-shaped piece of the sheet stock. The driving end is formed at the end of the leg of the T and has a hole/aperture for accommodating a drive pin engaged by the synchronizing ring. The driven end is formed near the head or intersection of the leg and the arms of the T. Near the head/intersection, the leg has a hole/aperture for receiving a threaded shaft/stem of the vane.

The arms are bent around to overlap. The overlapping one of the arms has an aperture through which the vane shaft/stem passes in the mounted condition. The overlapped arm end protrudes over the overlapping arm aperture. A proximal portion of the vane shaft/stem is clamped by abutting contact of both a proximal edge of the overlapping arm aperture and the overlapped arm distal end.

To install the vane arm of the ′260 patent to its associated vane, a tool is used to spread the arms slightly apart to reduce the overlap of the overlapped arm distal end and the overlapping arm aperture. The spreading provides clearance to install with the overlapping arm aperture passing over the threaded distal end portion of the shaft and over a region proximal of the threads having opposite parallel flats. Ultimately, the shaft passes through the head end aperture of the leg allowing a tab washer and nut to be installed and tightened down.

Releasing of the tool allows partial relaxation of the arms to compressively engage the shaft/stem proximal portion flats for registry. The head end hole in the ′260 patent is partially circular with a circular arc and a chord providing a flat perimeter surface. In complementary fashion, the shaft threaded end portion has a flat interrupting the threads. The cooperation of the hole flat and shaft flat provides rotational keying to predetermine a single installation orientation of the vane arm relative to the vane.

### SUMMARY

One aspect of the disclosure involves a vane comprising: an airfoil having a first end and a second end; and a first shaft protruding from the first end of the airfoil. The first shaft has: a threaded distal portion; and, proximally of the threaded distal portion, a first lateral facet and a second lateral facet opposite the first lateral facet. An upper end of the first facet is axially recessed relative to an upper end of the second facet.

A further embodiment of any of the foregoing embodiments may additionally and/or alternatively include a second shaft protruding from the second end of the airfoil.

In a further embodiment of any of the foregoing embodiments, additionally or alternatively: the upper end of the first facet is axially recessed relative to the upper end of the second facet by at least 10% of a spacing between the first facet and second facet.

In a further embodiment of any of the foregoing embodiments, additionally or alternatively, The vane of claim 1 wherein the first shaft has: a third facet between the first facet and the threaded distal portion; and a fourth facet between the second facet and the threaded distal portion.

In a further embodiment of any of the foregoing embodiments, additionally or alternatively: a first step separates the first facet from the third facet so that the third facet is radially recessed relative to the first facet but parallel thereto; and a second step separates the fourth facet from the second facet so that the fourth facet is radially recessed relative to the second facet but parallel thereto.

In a further embodiment of any of the foregoing embodiments, additionally or alternatively, the first step and the second step each have a run of at least 0.50 millimeter.

In a further embodiment of any of the foregoing embodiments, additionally or alternatively, the first facet is parallel to the second facet.

In a further embodiment of any of the foregoing embodiments, additionally or alternatively, the first facet is the same distance from an axis of the shaft as is the second facet.

In a further embodiment of any of the foregoing embodiments, additionally or alternatively, a second shaft protrudes from the second end of the airfoil.

A further embodiment of any of the foregoing embodiments may additionally and/or alternatively include a vane assembly including the vane and further comprising a vane arm having: a first end and a second end; a shank extending between the first end and the second end and having a first face and a second face. A first hole is in the shank proximate the first end. A second hole is in the shank proximate the second end. A first tab projects laterally from the shank proximate the second end and has: a bend; and a distal portion distally of the bend. A second tab projects laterally from the shank proximate the second end laterally opposite the first tab and has: a bend; a distal portion distally of the bend and partially overlapping the first tab distal portion. A third hole is in the second tab distal portion. and has a proximal edge and a distal edge. A nut threaded to the shaft distal portion holds the vane arm to a shoulder of the shaft. The shaft first facet abuts the proximal edge of the third hole and the shaft second facet abuts the first tab.

In a further embodiment of any of the foregoing embodiments, additionally and/or alternatively, the first tab distal portion is overlapping and spaced apart from and has a face facing the shank second face; and the second tab distal portion is overlapping and spaced apart from and has a face facing the shank second face.

In a further embodiment of any of the foregoing embodiments, additionally or alternatively, a tab washer is between the nut and vane arm and has a tab received in an open channel in the second end.

A further embodiment of any of the foregoing embodiments may additionally and/or alternatively include a pin mounted in and protruding from the first hole.

A further embodiment of any of the foregoing embodiments may additionally and/or alternatively include a vane stage comprising a plurality of said vane assemblies and further comprising: a synchronizing ring coupled to the vane arms and having an axis; and for each vane assembly one or more bearings mounting the vane for rotation about an axis of the vane, wherein rotation of the synchronizing ring about its axis rotates the vanes about their respective axes.

A further aspect of the disclosure involves a vane assembly comprising: a vane having an airfoil and a shaft protruding from an end of the airfoil; and a vane arm. The vane arm comprises: a first end and a second end; a shank extending between the first end and the second end and having a first face and a second face; a first hole in the shank proximate the first end; a second hole in the shank proximate the second end. A first tab projects laterally from the shank proximate the second end and has: a bend; and a distal portion distally of the bend. A second tab projects laterally from the shank proximate the second end laterally opposite the first tab and has: a bend; a distal portion distally of the bend and partially overlapping the first tab distal portion. A third hole is in the second tab distal portion and has a proximal edge and a distal edge. The shaft has a first facet abutting the proximal edge of the third hole and a second facet abutting the first tab, an upper end of the first facet axially recessed relative to an upper end of the second facet.

In a further embodiment of any of the foregoing embodiments, additionally and/or alternatively, the first tab distal portion is overlapping and spaced apart from and has a face facing the shank second face; and the second tab distal portion is overlapping and spaced apart from and has a face facing the shank second face.

In a further embodiment of any of the foregoing embodiments, additionally or alternatively, the upper end of the first facet is axially recessed relative to the upper end of the second facet by at least 50% of a thickness of the second tab.

In a further embodiment of any of the foregoing embodiments, additionally or alternatively, the upper end of the first facet is axially recessed relative to the upper end of the second facet by 50% to 150% of the thickness.

In a further embodiment of any of the foregoing embodiments, additionally or alternatively, the second hole is other than circular in footprint to provide rotational keying.

A further aspect of the disclosure involves a vane assembly comprising: a vane having an airfoil and a shaft protruding from an end of the airfoil; and a vane arm. The vane arm comprises: a first end and a second end; a shank extending between the first end and the second end and having a first face and a second face; a first hole in the shank proximate the first end; a second hole in the shank proximate the second end. A first tab projects laterally from the shank proximate the second end and has: a bend; and a distal portion distally of the bend. A second tab projects laterally from the shank proximate the second end laterally opposite the first tab and has: a bend; a distal portion distally of the bend and partially overlapping the first tab distal portion. A third hole is in the second tab distal portion and having a proximal edge and a distal edge. The shaft has a first facet abutting the proximal edge of the third hole and a second facet abutting the first tab. An asymmetry between the first facet and the second facet providing means for preventing an installation of the vane arm to the shaft in a 180° rotation about an axis of a threaded portion of the shaft.

In a further embodiment of any of the foregoing embodiments, additionally and/or alternatively, the first tab distal portion is overlapping and spaced apart from and has a face facing the shank second face; and the second tab distal portion is overlapping and spaced apart from and has a face facing the shank second face.

In a further embodiment of any of the foregoing embodiments, additionally or alternatively, the vane arm is a nickel alloy.

In a further embodiment of any of the foregoing embodiments, additionally or alternatively, the asymmetry is an asymmetry of axial positions of upper ends of the first facet and second facet.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a view of a vane assembly.

FIG. 1A is an enlarged view of a vane actuating arm region of the assembly of FIG. 1.

FIG. 2 is a side view of the vane arm region.

FIG. 3 is an end view of the vane arm region.

FIG. 4 is a view of the vane arm.

FIG. 5 a view of the vane.

FIG. 6 is a sectional view of the vane arm region taken along line 6-6 of FIG. 2.

FIG. 7 is a sectional view of the vane arm region taken along line 7-7 of FIG. 6.

FIG. 8 is a sectional view of the vane arm region taken along line 8-8 of FIG. 3.

FIG. 9 is an outer diameter (OD) view of a distal end of an outer diameter (OD) shaft section of the vane of the assembly.

FIG. 10 is a first side view of a vane mounting portion of the OD shaft section.

FIG. 11 is a second side view of a vane mounting portion of the OD shaft section.

FIG. 12 is an inner diameter (ID) face view of a vane arm of the assembly.

Like reference numbers and designations in the various drawings indicate like elements.

### DETAILED DESCRIPTION

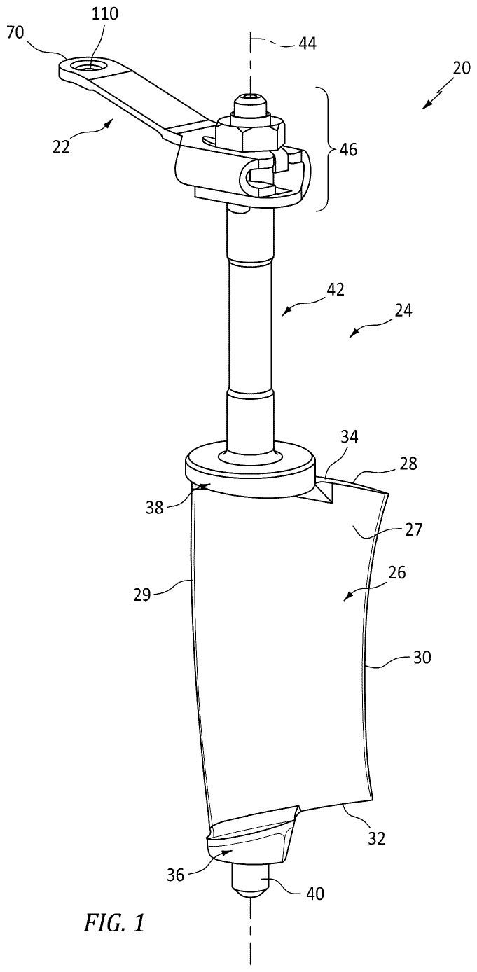

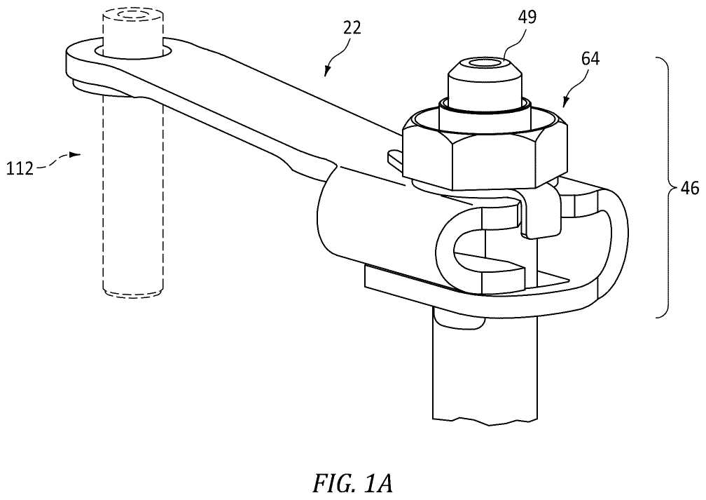

FIG. 1 shows a vane assembly 20 including vane arm 22 and vane 24 configured as a modification of the baseline of the ′260 patent. The vane 24 includes an airfoil 26 having a pressure side 27, a suction side 28, a leading edge 29, and a trailing edge 30. The airfoil extends along a span from an inner diameter (ID) end 32 to an outer diameter (OD) end 34. Such ID and OD are measured essentially relative to the engine centerline. The airfoil ID and OD ends respectively merge, along forward/leading portions thereof, with respective ID and OD platforms 36 and 38. Respectively inward and outward from the platforms 36 and 38 are an ID shaft 40 and an OD shaft 42. The shafts are coaxial along a vane axis 44 which forms an axis of rotation and axis of threads of a threaded portion 50 discussed below. The OD shaft 42 includes a distal mounting section 46 for mating with the vane arm 22.

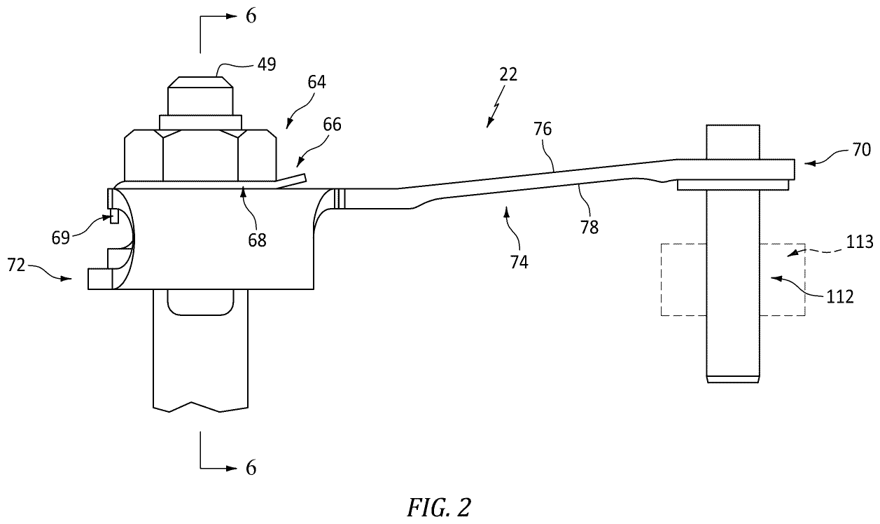

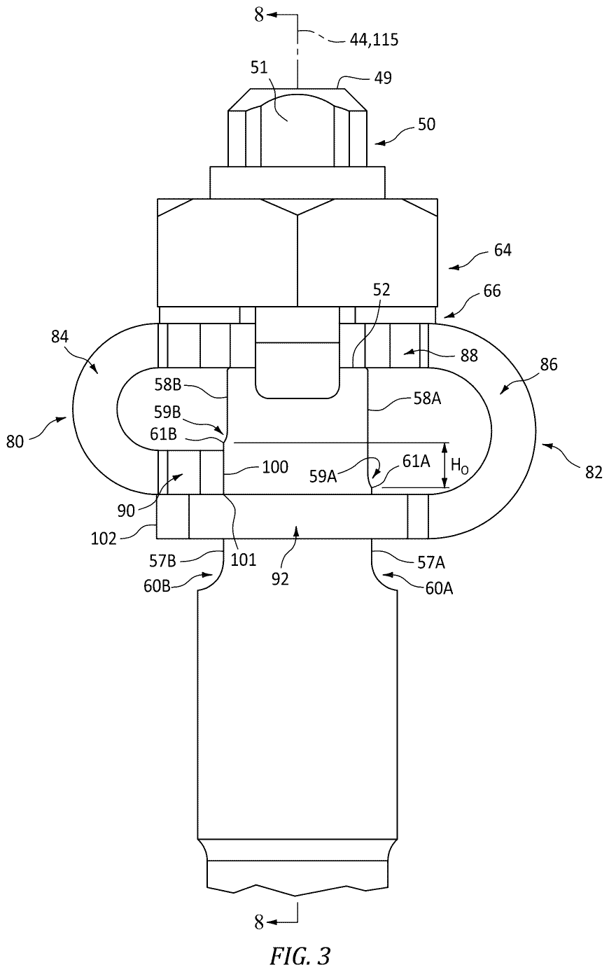

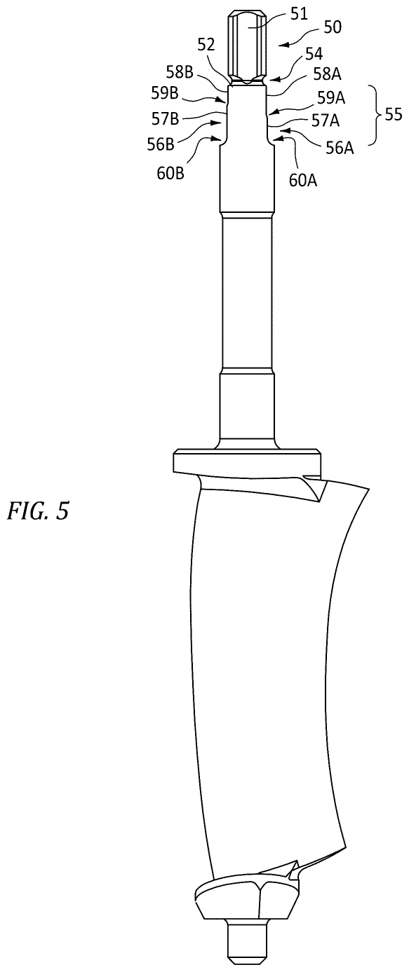

The mounting section 46 includes an externally threaded section/region/portion 50 (FIG. 3) with a shoulder surface 52 radially inward thereof or proximal relative to the airfoil. The shoulder 52 is separated from the threaded section by a necked region 54 (FIG. 5). Below/inward of the shoulder is a faceted section 55 (FIG. 5) having opposed first and second faces 56A and 56B. Each face 56A, 56B has a lower/proximal facet 57A, 57B (FIG. 3) and an upper/distal facet 58A, 58B. For each face, the upper facet extends downward from the shoulder 52 with respective concave transitions 59A, 59B to the associated lower facet. Similarly, the lower facets 57A, 57B extend to respective concave transitions 60A, 60B to intact circular surface of the stem. The respective lower facets have upper edges 61A, 61B. These facets 56A, 56B, 57A, 57B extend, along a substantial majority of their axial lengths parallel to the axis 44. FIG. 2 also shows a nut 64 installed to the threaded section and a tab washer 66 between the nut and the arm. The tab washer has an annular body 68 and a tab 69 bent at an angle thereto.

The arm 22 (FIG. 2) extends generally from a first end 70 to a second end 72. In this example, the first end 70 is a driving end and the second end 72 is a driven end. The example arm 22 is formed from stamped/bent sheet metal stock (e.g., nickel-based alloy/superalloy such as AMS 5596-UNS N07718 (nominal 52.5Ni—19Cr—3.0Mo—5.1Cb (Nb)—0.90Ti—0.50Al—18Fe)). The arm 22 has a shank 74 extending between the first end and the second end and having a first face 76 and a second face 78. These faces 76 and 78 may correspond to faces of the sheet stock or relieved portions thereof. In the example, a portion of the second face 78 is relieved relative to the original sheet stock for lightening. In an example method of manufacture, the stamped sheet stock piece may have an initial cut form of a generally T-like planform/footprint with the first end 70 being the lower end of the leg of the T. The arms of the T form respective tabs projecting laterally from the shank proximate the second end.

FIG. 3 shows the arms/tabs 80 and 82 in their bent configurations with bends 84, 86, respectively extending from a second end portion 88 of the shank to respective distal portions 90, 92 of the arms 80 and 82 (distally of the respective bends 84 and 86). The bends 84, 86 are such that the respective distal portions 90, 92 have faces facing the shank second face 78. These faces may be formed from the same face of original stock as the second face 78. The distal portions overlap the shank (i.e., a line through the shank perpendicular to the faces 76, 78 also intersects the distal portions) and are spaced apart therefrom. Example bends have the effect of forming an essentially 180° U-turn. The bend 84 is of tighter curvature than the bend 82 to allow the distal portion 92 to overlap the distal portion 90 (i.e., the distal portion 90 is between the distal portion 92 and the shank). The tabs extend to respective distal ends 100, 102.

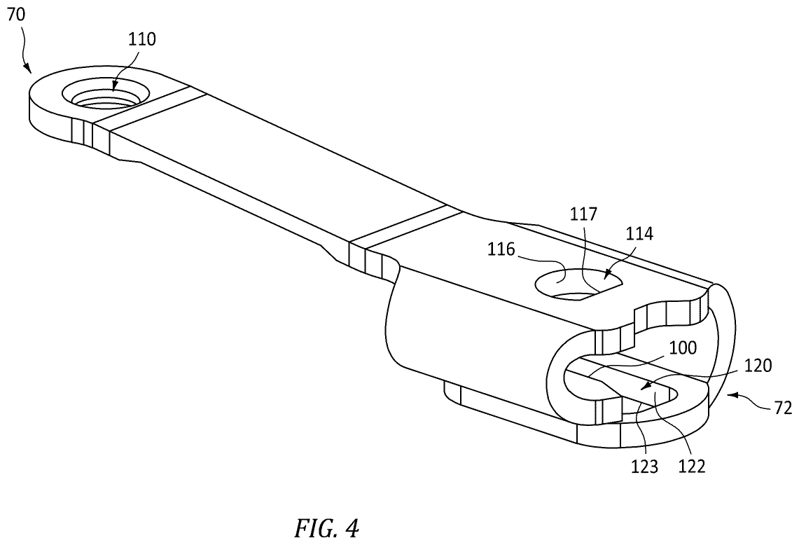

The example vane arm has exactly three through-holes. A first through-hole 110 (FIG. 4) is adjacent the first end 70 for receiving a driving pin 112 (FIGS. 1A&2) which, in turn, is mounted to a synchronizing ring 113 (FIG. 2) in common with the pins of the other vanes of the stage and sharing a central longitudinal axis with the engine and the vane stage. A second through-hole 114 is near the second end and receives the OD shaft 42. The example second hole 114 is of partial circular cross-section dimensioned to just accommodate the threaded section 50 and allow the adjacent portion of the surface 78 to rest atop the shoulder surface 52. The hole 110 has an axis 111 shared with the pin 112. The second hole 114 circular portion 116 has an axis 115 coaxial with the axis 44 in a mounted condition. FIG. 4 also shows the hole 114 as having a perimeter portion 117 formed as a chord of the otherwise circular planform of the hole. This chord forms a keying feature cooperating with a corresponding flat 51 (FIG. 5) that interrupts the threads of the threaded section/region 50. An example hole-to hole on-center distance or separation between axes 111 and 115 is about 1.5 inch (38 mm), more broadly 25 mm to 51 mm or 37 mm to 43 mm. An example overall arm length is about 1.7 inch (43 mm), more broadly 30 mm to 80 mm or 35 mm to 60 mm.

A third hole 120 (FIG. 7) is formed in the distal portion 92 of the second tab 82. The example third hole 120 is formed as a rounded-corner parallelogram (shown as a right parallelogram/rectangle) having a proximal edge 122, a distal edge 124 and end edges 126 and 128. The distal edge 100 of the first tab is generally parallel to the distal edge 124 of the third hole. In the relaxed condition of the arm, the third hole is partially overlapped or overlaps the first tab distal portion 90.

In the properly installed condition, the arm end 100 (FIGS. 5 and 7) is in contact with the facet 57B and the hole 120 proximal edge 122 is in contact with the facet 57A. There may be a slight gap 129 between the hole 120 distal edge 124 and the facet 57B.

The modification relative to the ′260 patent partially shifts the keying function from the head end hole of the leg of the T to the arms of the T. This keying is achieved by having an asymmetry in the facets on opposite sides of the axis that engage the two arms. The example asymmetry involves differing heights (axial positions) of the upper ends 61A, 61B of the two proximal facets 57A, 57B with steps 59A, 59B thereabove to two additional distal facets 58A, 58B that extend to the shoulder 52 below the threaded portion 54.

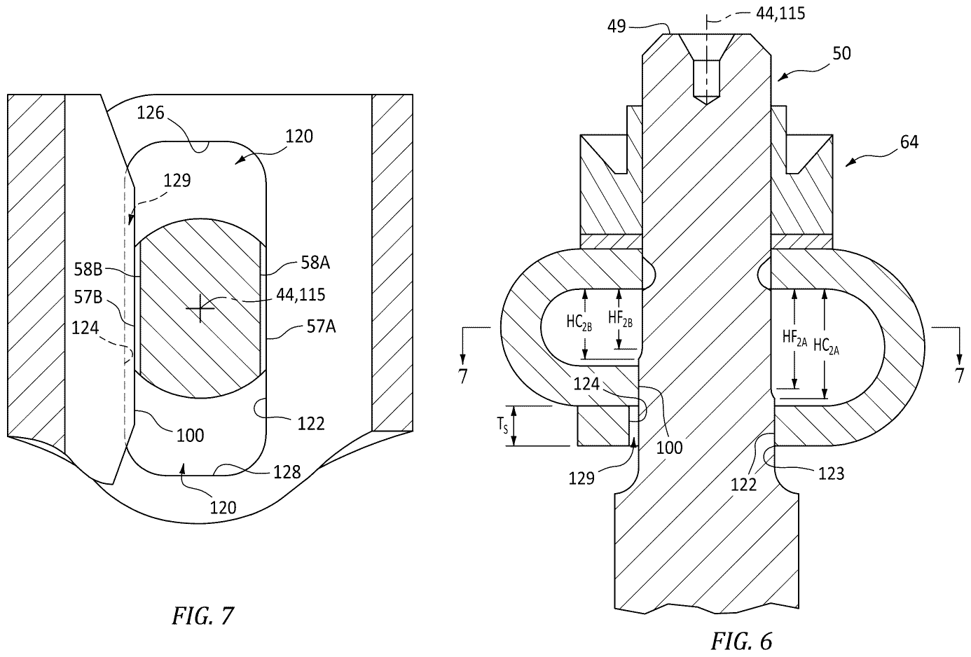

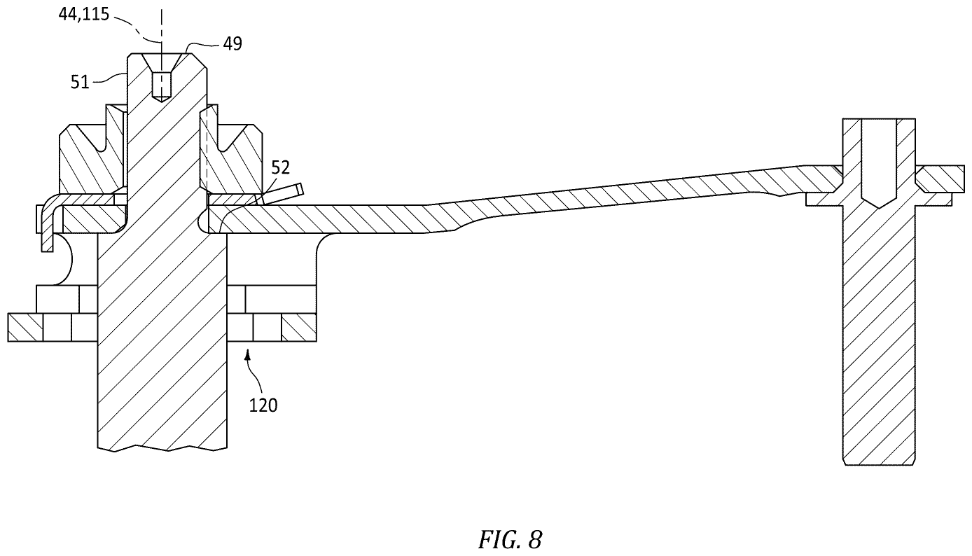

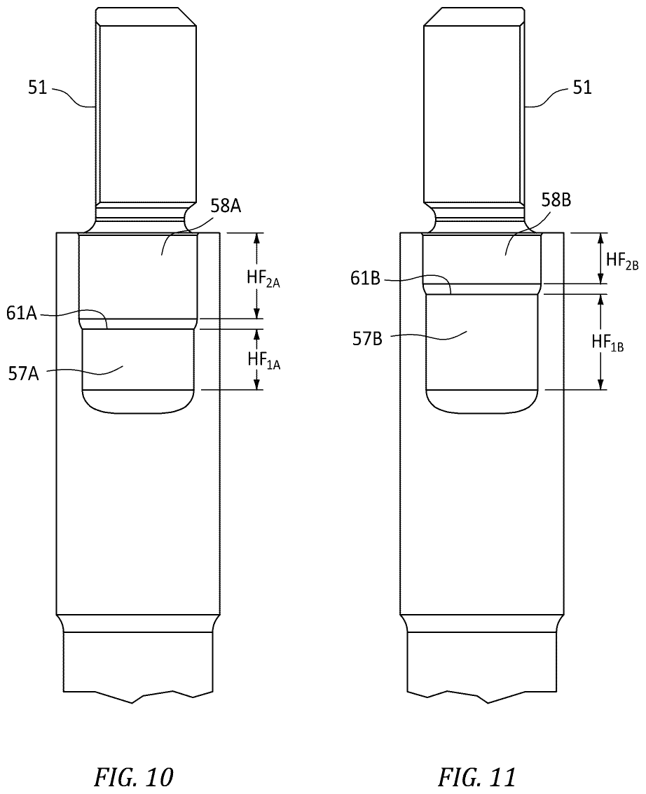

The example asymmetry involves an axial separation of the upper ends of the facets 57A, 57B by an axial span or height H_{O}. FIGS. 10 and 11, in combination, show the facet 57A as having a height HF_{1A}, and the facet 58A having such a span HF_{2A}. Similarly, the facets 57B and 58B have heights HF_{1B}, HF_{2B}. The transitions or shoulders/steps 59A, 59B have heights significantly smaller than either of these. FIG. 6 also shows combined heights HC_{2A} and HC_{2B} for the upper facets and their associated transitions 59A, 59B.

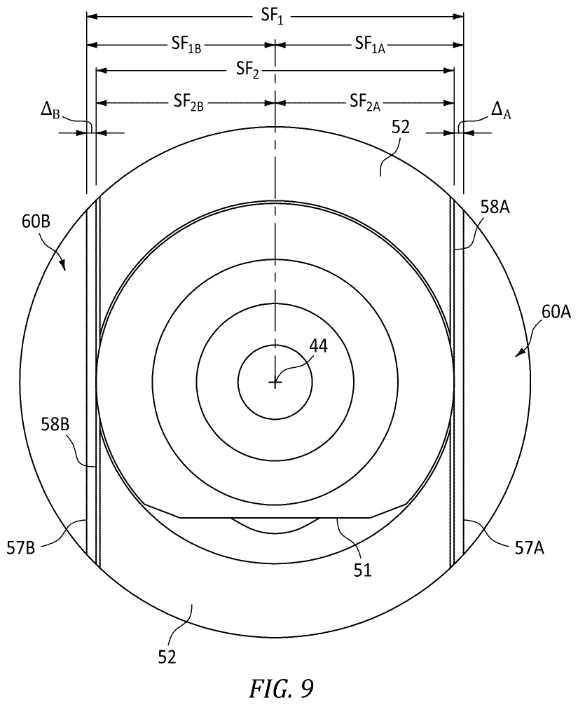

FIG. 9 shows radial separations of the facets from the central axis as SF_{1A}, SF_{2A}, SF_{1B}, SF_{2B}. (for respective combined spacings (or widths between diametrically opposite facets) of SF₁, SF₂). In the illustrated example, these are the same for both faces. Thus, the differences or the run of the step between the facets of a given pair Δ_{A} and Δ_{B} are the same. Example Δ_{A} and Δ_{B} are about 1.1 millimeter, more broadly at least 0.50 millimeter or at least 0.75 millimeter with optional upper range limits of 1.5 millimeter or 2.5 millimeter.

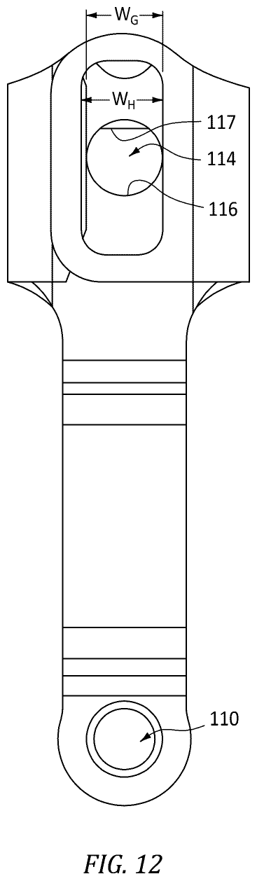

In a normal installation situation, the arms are in their relaxed condition and lateral spacing or gap width W_{G} (FIG. 12) between the faces 100, 122 is greater than the spacing SF₂ between facets 58A, 58B but slightly less than the spacing SF₁ between facets 57A, 57B. Thus, the aperture 120 (width W_{H} greater than SF₁) may slide over the vertical span occupied by the facet 58B so that, during a portion of such movement, the second arm 82 distal portion 92 will be fully within that span and the first arm distal portion 90 will at least be partially within that span. Eventually, one or both of the lower corner/edge 101 (FIG. 3) of the end 100 and the lower corner/edge 123 (FIG. 6) of the hole 120 face 122 will contact the respective transition 59B, 59A and impede further movement absent a driving force to expand the arms laterally outward. This driving force may be imposed by applying and tightening the nut 64 which causes a wedging/camming action due to the slope of the transitions 59B, 59A cooperating with the edges 101, 123. Eventually, such camming action will drive the edges 101, 123 over the lower facet upper edges 61B, 61A and allow seating in the ultimate installed condition of FIG. 6.

Thus, during this process, at the point of initial contact between the edges 101 and 123 and the associated transition 59B, 59A, a given amount of the stem below its upper end 49 (FIG. 3) will protrude beyond the shank of the arm. This amount of protrusion provides a visible indication of proper orientation as discussed further below. Despite the keying features on the stem threaded portion 50 and arm hole 114 provided by the facets 51 and 117, misinstallation is possible. The small size of such features may allow wear or damage to provide enough accommodation for misorientation.

If the arm is attempted to be misinstalled other than essentially 180° misoriented about the axis 44, one or both arms will interfere with the intact circular perimeter of the shoulder 52 90° circumferentially between the facets as in the ′260 patent. This condition will be clearly evident to the installer because the movement will be stopped with a much reduced height of protrusion of the stem end 49 from the arm shank. In the illustrated example, such protrusion would be almost zero.

At an essentially 180° misorientation, the arms may pass over the shoulder 52 but then encounter the asymmetry of the axial positions of the transitions/steps 59A, 59B between the facets of a given circumferentially aligned pair. Thus, for example, in such a mis-registered installation attempt, the lower edge 123 of the hole 120 face 122 may contact the step 59B and interfere with further movement. The effect is that the amount of protrusion of the stem from the shank is reduced by the height H_{O} relative to the corresponding stage of correct installation. This height H_{O} may, therefore, be chosen to be sufficient to provide a visually recognizable reduction in protrusion. When presented with such visual indication of the mis-installed situation, the installer would know to either reorient by 180° or discard one or both of the arm and stem due to whatever the defect is in the keying provided by the cooperation of the hole 114 and threaded portion 50. This is in distinction to a lack of such transition asymmetry potentially allowing two alternative installation orientations 180° from each other.

Example H_{O} may be very close to the thickness T_{S} of the arms (FIG. 6) which may also represent the thickness of the original arm sheetstock. Thus, example H_{O} may be 50% to 150% of T_{S}, more particularly, 75% to 125% or 90% to 110%. Alternatively expressed, H_{O} may be an example about 30% of the spacing SF₁, measured across the axis 44, more broadly 10% to 50% or 20% to 40%. or 25% to 35%. Also, the step runs Δ_{A} and Δ_{B} may be an example 2% of S_{F1}, more broadly 1.0% to 5.0% or 1.5% to 3.5%.

In alternative embodiments (not shown), with keying provided by the arms/tabs, the keying function may be removed from the threaded portion 50 of the shaft and the head end hole 114. Thus, the head end hole 114 may be fully circular in footprint and the shaft threads may be uninterrupted.

Component materials and manufacture techniques and assembly techniques may be otherwise conventional. This may involve stamping/machining/press braking from plate stock.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

One or more embodiments have been described. Nevertheless, it will be understood that various modifications may be made. For example, when applied to an existing baseline vane arm configuration, details of such baseline may influence details of particular implementations. Accordingly, other embodiments are within the scope of the following claims.

What is claimed is:

1. A vane comprising:
an airfoil having a first end and a second end; and
a first shaft protruding from the first end of the airfoil and having:
a threaded distal portion; and
proximally of the threaded distal portion, a first lateral facet and a second lateral facet opposite the first lateral facet,
wherein:
an upper end of the first facet is axially recessed relative to an upper end of the second facet.

2. The vane of claim 1 further comprising:
a second shaft protruding from the second end of the airfoil.

3. The vane of claim 1 wherein:
the upper end of the first facet is axially recessed relative to the upper end of the second facet by at least 10% of a spacing between the first facet and second facet.

4. The vane of claim 1 wherein the first shaft has:
a third facet between the first facet and the threaded distal portion; and
a fourth facet between the second facet and the threaded distal portion.

5. The vane of claim 4 wherein:
a first step separates the first facet from the third facet so that the third facet is radially recessed relative to the first facet but parallel thereto; and
a second step separates the fourth facet from the second facet so that the fourth facet is radially recessed relative to the second facet but parallel thereto.

6. The vane of claim 5 wherein:
the first step and the second step each have a run of at least 0.50 millimeter.

7. The vane of claim 1 wherein:
the first facet is parallel to the second facet.

8. The vane of claim 1 wherein:
the first facet is the same distance from an axis of the shaft as is the second facet.

9. The vane of claim 1 further comprising:
a second shaft protruding from the second end of the airfoil.

10. A vane assembly including the vane of claim 1 and further comprising a vane arm having:
a first end and a second end;
a shank extending between the first end and the second end and having a first face and a second face;
a first hole in the shank proximate the first end;
a second hole in the shank proximate the second end;
a first tab projecting laterally from the shank proximate the second end and having:
a bend; and
a distal portion distally of the bend; and
a second tab projecting laterally from the shank proximate the second end laterally opposite the first tab and having:
a bend;
a distal portion distally of the bend partially overlapping the first tab distal portion; and
a third hole in the second tab distal portion and having a proximal edge and a distal edge, wherein:
a nut threaded to the shaft distal portion holds the vane arm to a shoulder of the shaft; and
the shaft first facet abuts the proximal edge of the third hole and the shaft second facet abuts the first tab.

11. The vane assembly of claim 10 wherein:
a tab washer is between the nut and vane arm and has a tab received in an open channel in the second end.

12. The vane assembly of claim 10 further comprising:
a pin mounted in and protruding from the first hole.

13. A vane stage comprising a plurality of vane assemblies of claim 10 and further comprising:
a synchronizing ring coupled to the vane arms and having an axis; and
for each vane assembly one or more bearings mounting the vane for rotation about an axis of the vane, wherein rotation of the synchronizing ring about its axis rotates the vanes about their respective axes.

14. A vane assembly comprising a vane having an airfoil and a shaft protruding from an end of the airfoil and a vane arm, the vane arm comprising:
a first end and a second end;
a shank extending between the first end and the second end and having a first face and a second face;
a first hole in the shank proximate the first end;
a second hole in the shank proximate the second end;
a first tab projecting laterally from the shank proximate the second end and having:
a bend; and
a distal portion distally of the bend; and
a second tab projecting laterally from the shank proximate the second end laterally opposite the first tab and having:
a bend;
a distal portion distally of the bend and partially overlapping the first tab distal portion; and
a third hole in the second tab distal portion and having a proximal edge and a distal edge,
wherein:
the shaft has a first facet abutting the proximal edge of the third hole and a second facet abutting the first tab, an upper end of the first facet axially recessed relative to an upper end of the second facet.

15. The vane assembly of claim 14 wherein:
the upper end of the first facet is axially recessed relative to the upper end of the second facet by at least 50% of a thickness of the second tab.

16. The vane assembly of claim 14 wherein:
the upper end of the first facet is axially recessed relative to the upper end of the second facet by 50% to 150% of the thickness.

17. The vane assembly of claim 14 wherein:
the second hole is other than circular in footprint to provide rotational keying.

18. A vane assembly comprising a vane having an airfoil and a shaft protruding from an end of the airfoil and a vane arm, the vane arm comprising:
a first end and a second end;
a shank extending between the first end and the second end and having a first face and a second face;
a first hole in the shank proximate the first end;
a second hole in the shank proximate the second end;
a first tab projecting laterally from the shank proximate the second end and having:
a bend; and
a distal portion distally of the bend; and
a second tab projecting laterally from the shank proximate the second end laterally opposite the first tab and having:
a bend;
a distal portion distally of the bend and partially overlapping the first tab distal portion; and
a third hole in the second tab distal portion and having a proximal edge and a distal edge,
wherein:
the shaft has a first facet abutting the proximal edge of the third hole and a second facet abutting the first tab, an asymmetry between the first facet and the second facet providing means for preventing an installation of the vane arm to the shaft in a 180° rotation about an axis of a threaded portion of the shaft.

19. The vane assembly of claim 18 wherein:
the vane arm is a nickel alloy.

20. The vane assembly of claim 18 wherein:
the asymmetry is an asymmetry of axial positions of upper ends of the first facet and second facet.
